(19) United States
(12) Patent Application Publication
(10) Pub. No.: US 2008/0055909 A1
(43) Pub. Date: Mar. 6, 2008

(54) Method for Combining LED Lamp and Heat Dissipator and Combination Structure thereof

(76) Inventor: Jia-Hao Li, Sindian City (TW)

Correspondence Address: HDSL, 4331 STEVENS BATTLE LANE, FAIRFAX, VA, 22033, US

(21) Appl. No.: 11/469,819

(22) Filed: Sep. 1, 2006

(51) Int. Cl. F21V 29/00

(52) U.S. Cl. 362/294; 362/373

(57) ABSTRACT

A method for combining a LED lamp and a heat dissipator and a combination structure thereof A heat-conducting plate is mounted on the LED lamp. The heat-conducting plate is used for being detachably assembled with a heat dissipator. Elements such as screws, bolts, locking tools or rivets can be used to achieve the assembly. Therefore, when a disassembling operation is to be performed, with the disassembly of the above detachable elements, the LED lamp and the heat dissipator can be separated from each other without getting damaged due to the disassembly.

### BACKGROUND OF THE INVENTION

1. Field of the Invention

The present invention relates to a method for combining a LED lamp and a heat dissipator and a combination structure thereof, in which the heat dissipator can be detachably assembled on the LED lamp to facilitate the replacement of components.

2. Description of Prior Art

Since light-emitting diodes (LED) have many advantages, such as high intensity, electricity-saved and long life, they are widely used in the illumination of electronic devices or lamps. Further, in order to increase the range and intensity of illumination, a plurality of light-emitting diodes is usually assembled together to form a LED lamp set. However, with the increase of the number of light-emitting diodes and the development of high-intensity light-emitting diodes, the heat generated by those light-emitting diodes gradually increases. Therefore, it is an important issue for those skilled in this art to provide a heat-dissipating structure for LED lamp. The heat dissipator currently applied to the LED lamp mainly adopts the heat-dissipating device provided on the CPU of a computer. However, in the conventional process, a heat dissipator is adhered on a back surface of a LED lamp substrate having a plurality of light-emitting diodes. Further, the heat dissipator is connected onto the back surface of the LED lamp substrate by directly passing through a soldering furnace. Therefore, the LED lamp cannot be separated from the heat dissipator only if it is detached by a destructive manner. Therefore, when the light-emitting diodes on the LED lamp cannot illuminate normally or the number of the light-emitting diodes unable to illuminate has reached a value not conforming to the required standard, it is only to discard the whole set of LED lamp including the heat dissipator and cannot replace the damaged components only to save the cost.

In view of the above, the inventor proposes the present invention to overcome the above problems based on his expert experiences and deliberate researches.

### SUMMARY OF THE INVENTION

The present invention is to provide a method for combining a LED lamp and a heat dissipator and a combination structure thereof in order to solve the above problems and drawbacks. A heat-conducting plate is mounted on the LED lamp. The heat-conducting plate is used for being detachably assembled with a heat dissipa=tor. With the above structure, when a disassembling operation is to be performed, the LED lamp and the heat dissipator can be separated from each other without getting damaged due to the disassembly.

The present invention is to provide a method for combining a LED lamp and a heat dissipator, comprising the steps of:
a) preparing a LED lamp and a heat dissipator, the LED lamp comprising a plurality of light-emitting diodes, a substrate for providing the light-emitting diodes thereon, and a lamp cover provided outside the substrate;
b) adhering a heat-conducting plate on a back surface of the substrate of the LED lamp so as to thermally connect the heat-conducting plate with the substrate; and
c) detachably assembling the heat dissipator onto the heat-conducting plate of the LED lamp.

The present invention is to provide a combination structure of a LED lamp and a heat dissipator so as to be detachably assembled with a heat dissipator, which comprises a plurality of light-emitting diodes, a substrate for providing the light-emitting diodes thereon, and a lamp cover provided outside the substrate. The back surface of the substrate is provided with a heat-conducting plate on the top of the lamp cover. The heat-conducting plate is adhered and thermally connected to the substrate, so that the heat dissipator can be mounted and adhered onto the heat-dissipating plate from the top of the lamp cover.

### BRIEF DESCRIPTION OF THE DRAWINGS

FIG. 1 is an exploded perspective view of the LED lamp of the present invention;

FIG. 2 is a cross-sectional view of the LED lamp of the present invention;

FIG. 3 is an exploded perspective view of the LED lamp and the heat dissipator in accordance with the first embodiment of the present invention;

FIG. 4 is a partially cross-sectional view of the LED lamp and the heat dissipator in accordance with the first embodiment of the present invention;

FIG. 5 is a partially cross-sectional view of the LED lamp and the heat dissipator in accordance with the second embodiment of the present invention; and

FIG. 6 is a partially cross-sectional view of the LED lamp and the heat dissipator in accordance with the third embodiment of the present invention.

### DETAILED DESCRIPTION OF THE INVENTION

In order to make the Examiner to better understand the characteristics and the technical contents of the present invention, a description relating thereto will be made with reference to the accompanying drawings. However, it should be understood that the drawings are illustrative but not used to limit the scope of the present invention.

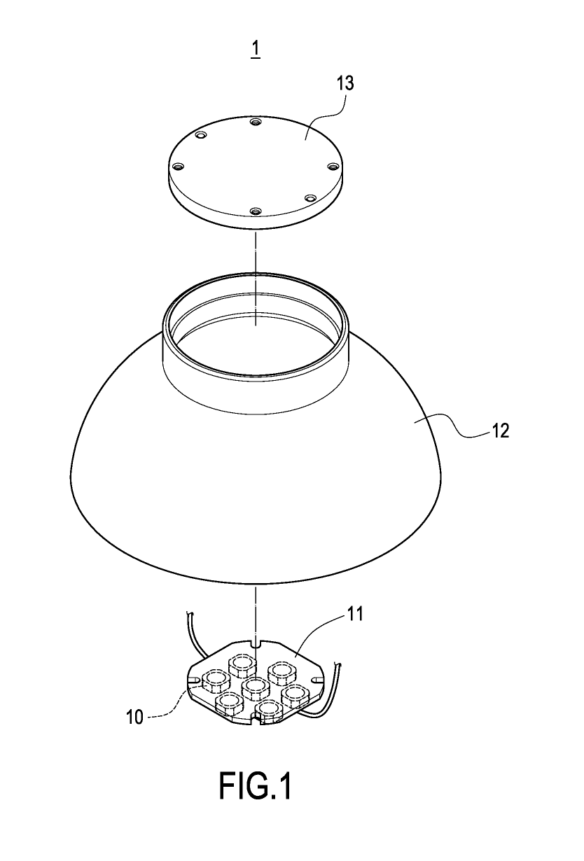

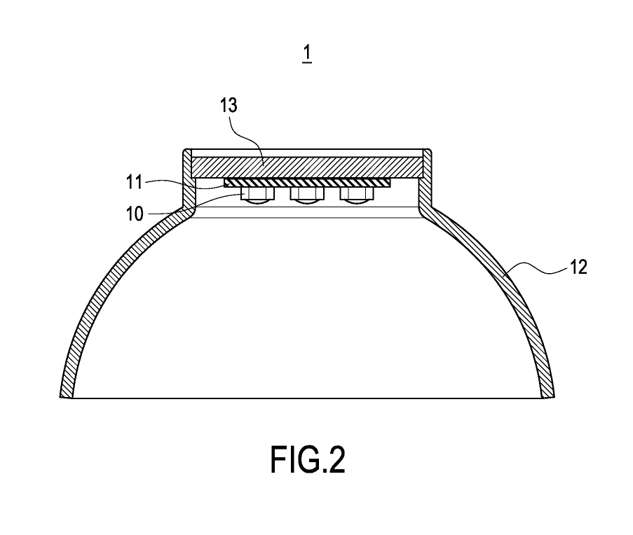

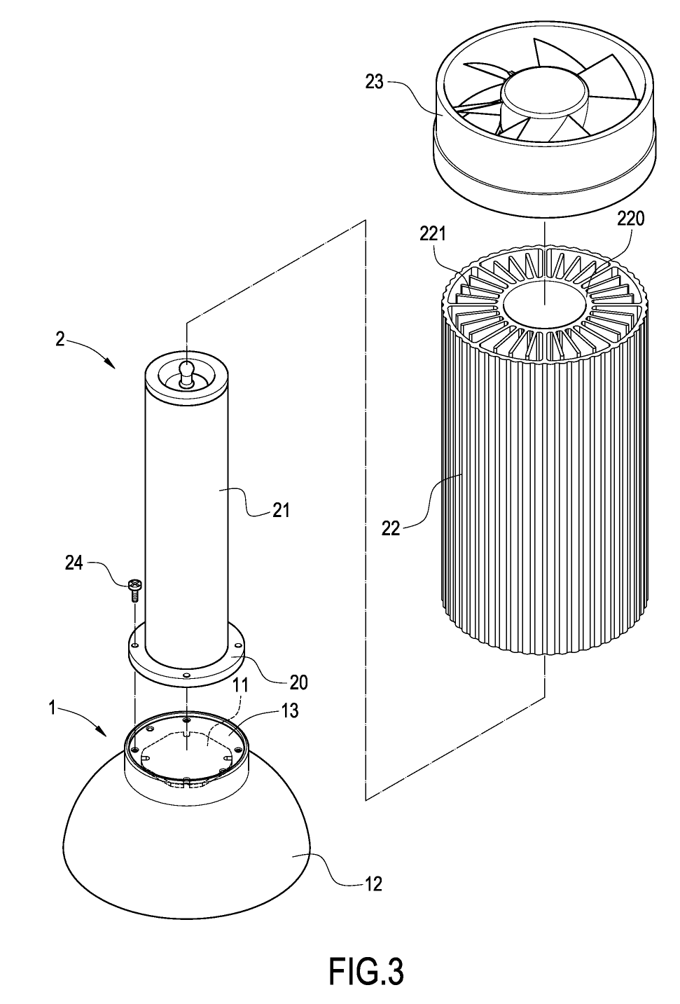

FIGS. 1 and 2 are an exploded perspective view and a cross-sectional view of the LED lamp of the present invention, respectively. FIG. 3 is an exploded perspective view of the LED lamp and the heat dissipator in accordance with the first embodiment of the present invention. The present invention provides a method for combining a LED lamp and a heat dissipator and a combination structure thereof. The LED lamp 1 comprises a plurality of light-emitting diodes (LED) 10, a substrate 11 for providing the light-emitting diodes 10 thereon, and a lamp cover 12 provided outside the substrate 11. The heat dissipator 2 is provided on a top of the lamp cover 12 for dissipating the heat generated by each light-emitting diode 10 on the LED lamp 1.

As shown in FIGS. 1 and 2, the LED lamp 1 is provided on a back surface of the substrate 11 with a heat-conducting plate 13 located on the top of the lamp cover 12. The heat-conducting plate 13 is adhered to and thermally connected with the substrate 11, so that the heat dissipator 2 can be mounted and adhered to the heat-conducting plate 13 from the top of the lamp cover 12. With reference to FIG. 3, the heat dissipator 2 comprises a heat-conducting base 20, a heat pipe 21 provided upright on the heat-conducting base 20, and a fins assembly 22 provided on the outer periphery of the heat pipe 21. The fins assembly 22 can be made by extrusion, such as aluminum extrusion, and has a hollow pillar 220 and heat-dissipating fins 221. The heat-dissipating fins are circumferentially provided in the periphery of the hollow pillar 220 and radially arranged. The heat pipe 21 can be inserted into the hollow pillar 220, so that the wall of the heat pipe 21 can abut against and contact with the inner wall of the hollow pillar 220, thereby to form the heat dissipator 2. In addition, a fan 23 can be provided above the heat dissiaptor 2 for blowing airflow toward each heat-dissipating fin 221 or sucking the airflow therefrom.

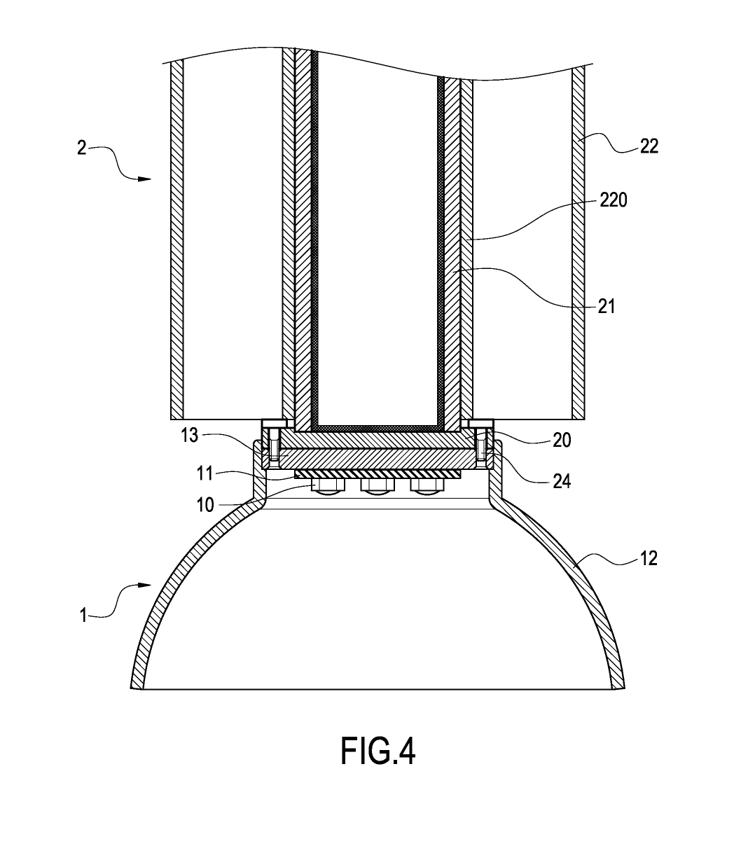

With reference to FIGS. 3 and 4, in the first embodiment of the present invention, a plurality of screwing elements 24 is provided in the periphery of the heat-conducting base 20 of the heat dissiaptor 2, and is screwed onto the heat-conducting plate 13 on the top of the of the LED lamp 1. In this way, the heat-conducting plate 13 and the heat-conducting base 20 can be vertically superposed and brought into face-to-face thermal contact with each other. At the same time, the heat dissipator 2 and the LED lamp 1 can be detachably assembled together via the screwing elements 24. The screwing element 24 may be a screw or bolt. With an inward or outward screwing operation of the screwing element, the effect of assembling or disassembling can be achieved. As a result, it is easy to replace the substrate 11 of the LED lamp 1 without discarding the heat dissipator 2.

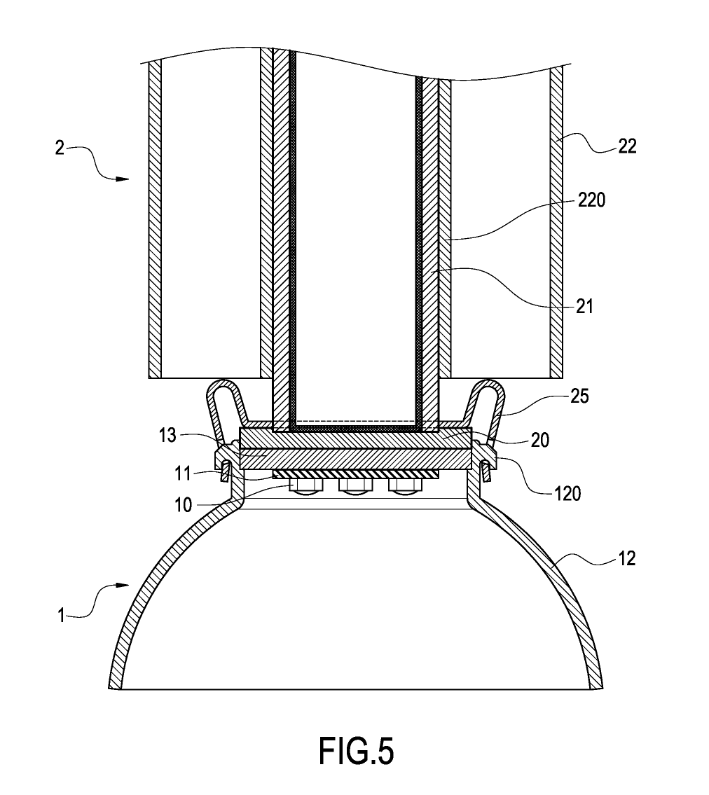

Further, with reference to FIG. 5, in the second embodiment of the present invention, a locking tool 25 abuts against the periphery of the heat-conducting base 20. The locking tool 25 is further locked to the outer periphery of the top of the lamp cover 12, and is provided in the periphery of the top of the lamp cover 12 with locking bumps 120 for being locked with the locking tool 25. In this way, the heat-conducting plate 13 and the heat-conducting base 20 are superposed to fixedly locked to each other. By unlocking the locking tool 25, the heat-conducting plate 13 and the heat-conducting base 20 can be separated form each other. Therefore, the effect of detachably assembling the heat dissipator and the LED lamp can be achieved.

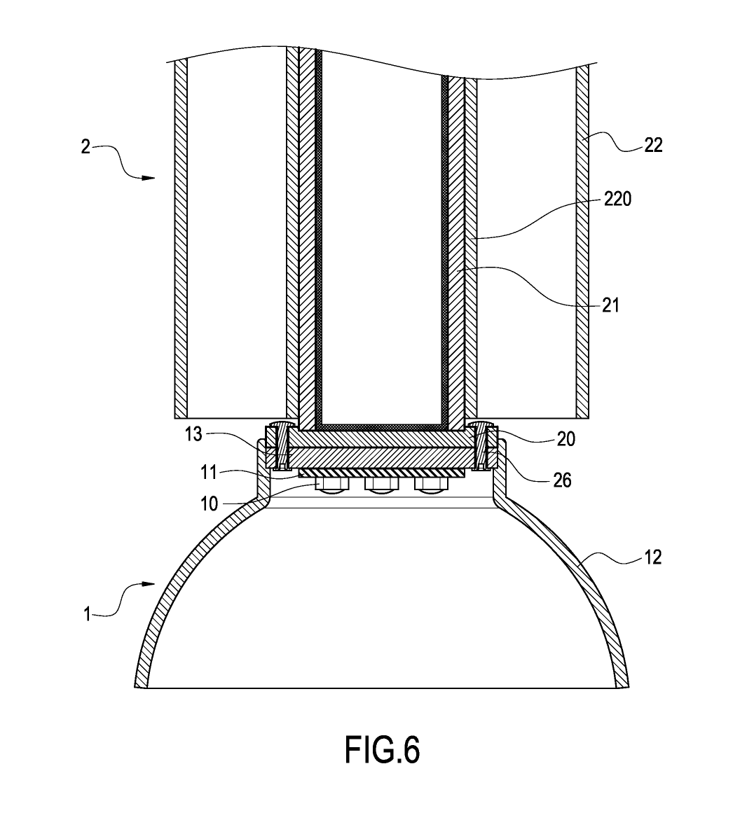

Further, with reference to FIG. 6, in the third embodiment of the present invention, the screwing element 24 in the above first embodiment is replaced by a riveting element 26. Although the riveting is not a completely detachable way of connecting, after the disassembling operation, the only damaged portion is the riveting element 26 such as rivet, but the original profiles of the heat-conducting plate 13 and the heat-conducting base 20 can remain undamaged. Therefore, the detachably assembling operation mentioned in the present invention also includes the riveting operation.

Therefore, with the above structure, the method for combining a LED lamp and a heat dissipator and the combination structure thereof can be achieved.

According to the above, the present invention indeed achieves the desired effects and solves the drawbacks of prior art. Further, the present invention involves the novelty and inventive steps and conforms to the requirements for an invention patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A method for combining a LED lamp and a heat dissipator, comprising the steps of:
preparing a LED lamp and a heat dissipator, the LED lamp comprising a plurality of light-emitting diodes, a substrate for providing the light-emitting diodes thereon, and a lamp cover provided outside the substrate;
adhering a heat-conducting plate on a back surface of the substrate of the LED lamp so as to thermally connect the heat-conducting plate with the substrate; and
detachably assembling the heat dissipator onto the heat-conducting plate of the LED lamp.

2. The method for combining a LED lamp and a heat dissipator according to claim 1, including using a screwing element to detachably assemble the heat dissipator onto the heat-conducting plate of the LED lamp.

3. The method for combining a LED lamp and a heat dissipator according to claim 1, including use a locking tool element to detachably assemble the heat dissipator onto the heat-conducting plate of the LED lamp.

4. The method for combining a LED lamp and a heat dissipator according to claim 1, including use a riveting element to detachably assemble the heat dissipator onto the heat-conducting plate of the LED lamp.

5. A combination structure of a LED lamp and a heat dissipator, used to be detachably assembled with a heat dissipator, comprising:
a plurality of light-emitting diodes;
a substrate for providing the light-emitting diodes thereon; and
a lamp cover provided outside the substrate,
wherein a back surface of the substrate is provided with a heat-conducting plate located on a top of the lamp cover, the heat-conducting plate is adhered and thermally connected to the substrate, so that the heat dissipator is mounted and adhered onto the heat-dissipating plate from the top of the lamp cover.
